(19) United States
(12) Patent Application Publication
(10) Pub. No.: US 2018/0046622 A1
(43) Pub. Date: Feb. 15, 2018

(54) Computer-Implemented System And Method For Dynamically Generating Documents Based On User Context

(71) Applicant: Palo Alto Research Center Incorporated, Palo Alto, CA (US)

(72) Inventor: Simon Tucker, Oakland, CA (US)

(21) Appl. No.: 15/233,861

(22) Filed: Aug. 10, 2016

(51) Int. Cl. G06F 17/30; G06Q 30/02

(52) U.S. Cl. CPC G06F 17/30011; G06F 17/3087; G06Q 30/0269

(57) ABSTRACT

A computer-implemented system and method for dynamically generating documents based on user context is provided. Blocks of document content are maintained and contextual data of a user is collected. The contextual data is compared to a set of stored models for the user and one or more models related to the user's context are identified. One or more content blocks are selected based on the identified models and a document is generated for the user by compiling the selected content blocks.

### FIELD

This application relates in general to generating documents, and in particular to a computer-implemented system and method for dynamically generating documents based on user context.

### BACKGROUND

Typically, documents are static, such that the same information is presented to a reader regardless of the context or knowledge possessed by the reader. For example, documents, such as posters, menus, and advertisements, are provided to all individuals that encounter those documents and do not change based on characteristics of those individuals. Thus, while information presented by such a document is relevant to some readers, other readers may find the information completely irrelevant or disinteresting.

The static nature of documents poses a challenge for advertisers and other document creators to create material that attracts a wide base of people. However, current attempts to create documents that appeal to a wide base are generally not successful because the documents can quickly become convoluted and confusing due to addressing the needs or interests of individuals with different levels of knowledge and context.

Further attempts to address a wide base by creating a multitude of separate documents that each cater towards users associated with a particular context or level of knowledge are not always effective. Generating separate documents requires an understanding of the types of users that will view the document, how the content of the document will relate to those users, and matching each user to the document having content appropriate for that user.

Therefore, there is a need for an approach to presenting document content to a user based on that user's level of knowledge and context to ensure that the content is relevant to the user. Preferably, the documents are dynamically generated for and presented to each individual user based on prior experiences and context.

### SUMMARY

To effectively capture a user's attention and interest, documents can be dynamically generated and presented based on that user's level of knowledge and context. Contextual data of the user is collected, and one or more models are selected for the user based on the contextual data. A document, such as an advertisement, is identified, and content of the advertising document is selected based on the identified user models. The selected content is then compiled and displayed to the user.

An embodiment provides a computer-implemented system and method for dynamically generating documents based on user context. Blocks of document content are maintained and contextual data of a user is collected. The contextual data is compared to a set of stored models for the user and one or more models related to the user's context are identified. One or more content blocks are selected based on the identified models and a document is generated for the user by compiling the selected content blocks.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a computer-implemented system for dynamically generating documents based on user context, in accordance with one embodiment.

FIG. 2 is a flow diagram showing a computer-implemented method for dynamically generating documents based on user context, in accordance with one embodiment.

FIG. 3 is a flow diagram showing, by way of example, a process for selecting relevant user models.

FIG. 4 is a block diagram showing, by way of example, a user model.

FIG. 5 is a flow diagram showing, by way of example, a process for generating documents.

### DETAILED DESCRIPTION

Documents, such as advertisements and menus, are typically static, and change or modification of the documents can sometimes require large amounts of time and expense. Due to their static nature, the documents are displayed to all individuals regardless of each individual's particular level of knowledge or context. Thus, some groups of individuals may find a document interesting, while other groups find the document irrelevant, uninteresting, or inapplicable. Unfortunately, numerous marketing and sales opportunities can be missed based on those groups of individuals that fail to find the document interesting or applicable. Dynamically tailoring documents to different individuals allows a business or other organization to provide content to the individuals in a manner and form that may appear more relevant to that particular individual.

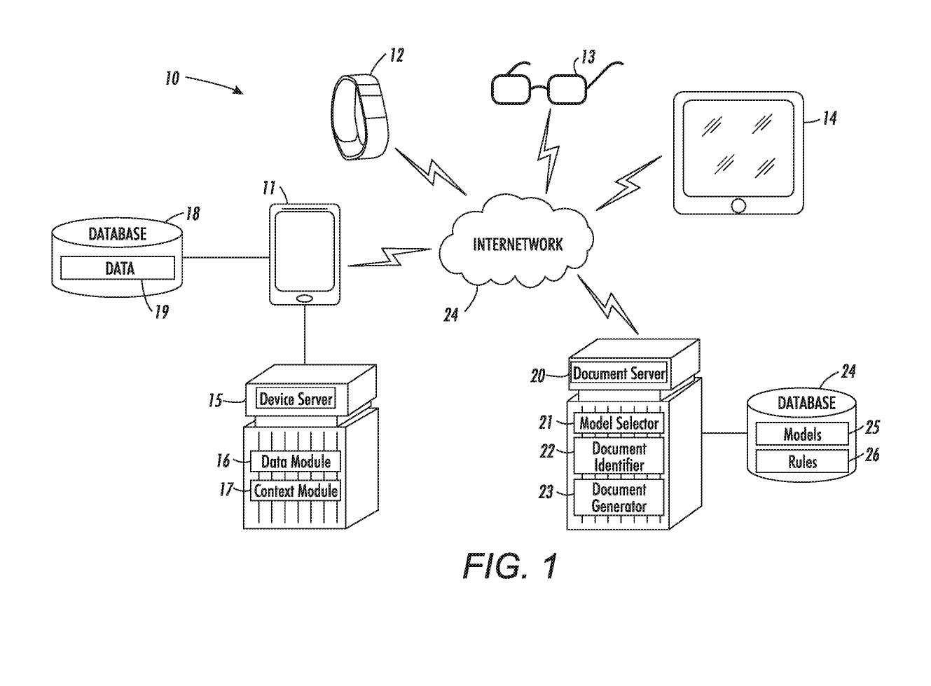

Documents can be dynamically generated based on previous experiences and a context of a user. Specifically, each document can render itself according to knowledge that a content creator wants to provide based on user context. FIG. 1 is a block diagram showing a computer-implemented system 10 for dynamically generating documents based on user context, in accordance with one embodiment. An individual user is associated with one or more mobile computing devices, including a cell phone 11, smart watch 12, head-mounted computing device 13, such as Google Glass manufactured by Google Inc., and tablet 14. However, other types of mobile computing devices are possible. Each of the computing devices 11-14 can collect contextual data 19 for the user, including one or more of location, time, temperature, acceleration, vital statistics, movement tracking, inventory, and other types of data related to the user's current surroundings. The contextual data 19 can be collected via sensors or sound or video recording devices within the mobile computing devices 11-14. For example, contextual data 19 can include a location of the user, which is obtained via GPS on a smart phone, a location of the user with respect to a particular piece of equipment, as identified via Bluetooth, time collected from a clock on the smart phone, and a video of the user obtained via a camera, such as on the mobile headset.

Once collected, the contextual data 19 can be stored in a database 18 associated with each mobile computing device 11-14. Each mobile computing device 11-14 can also be associated with a device server 15, which includes a data module 16 and a context module 17. The data module 16 can access the contextual data 19 from the database 18. The contextual data 19 collected by each device can then be transmitted to a single mobile computing device for processing via the context module 17 associated with that device to determine a context of the user, including a contextual scenario. Hereinafter, the terms “context” and “contextual scenario” are used interchangeably with the same intended meaning, unless otherwise indicated. In a further embodiment, each mobile computing device 11-14 can transmit the contextual data 19 to a document server 20, via an internetwork 27, such as the Internet, for identifying the user context based on the contextual data 19. The context can be identified using a combination of activity recognition and semantic modeling, or based directly on one or more items of contextual data.

The document server 20 includes a model selector 21, a document identifier 22 and a document generator 23, and is interconnected to a database 24 that stores user models 25 and content rules 26. The models 25 are stored for a plurality of users and each user can be associated with multiple models, which each represent a different contextual situation of the user and actions performed by the user during that situation. In one embodiment, the models can be generated at a specified time and updated routinely. However, in a further embodiment, at least a portion of the models can be generated in real time, as described in further detail in commonly-owned U.S. patent application Ser. No. ______, entitled “Computer-Implemented System And Method For Building Context Models In Real Time,” Docket No. 20141579US01, filed on Aug. 10, 2016, pending, the disclosure of which is incorporated by reference.

The model selector 21 identifies one or more of the models 25 for contextual situations that are related to the context of the user based on the collected contextual data. The document identifier 22 can identify a document associated with the user based on the collected contextual data. The document can include an advertisement, menu, sign, or other material that can be digitally displayed. Documents associated with the user can include those documents to which a user is faced, that are directly provided to the user, or that are in a general vicinity of the user. For example, if the collected contextual data provides that the user is seated on an airplane, the document can be identified as a digital advertisement to be displayed on a display screen at the user's seat. Once a document is identified, the document generator 23 tailors to the document for the user by identifying and compiling content of the identified document based on the user models. Subsequently, the tailored document is displayed.

The mobile computing devices 11-14 and servers 15, 20 can each include one or more modules for carrying out the embodiments disclosed herein. The modules can be implemented as a computer program or procedure written as source code in a conventional programming language and is presented for execution by the central processing unit as object or byte code. Alternatively, the modules could also be implemented in hardware, either as integrated circuitry or burned into read-only memory components, and each of the client and server can act as a specialized computer. For instance, when the modules are implemented as hardware, that particular hardware is specialized to perform the data quality assessment and other computers cannot be used. Additionally, when the modules are burned into read-only memory components, the computer storing the read-only memory becomes specialized to perform the data quality assessment that other computers cannot. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

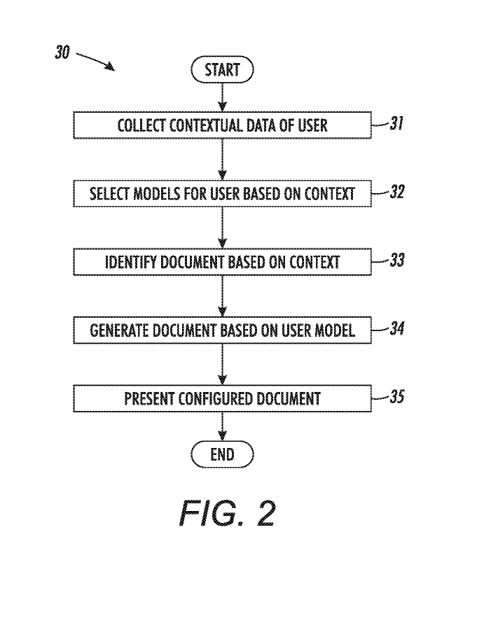

Documents can be tailored to interests and knowledge of an individual by dynamically compiling select content relevant to a recipient of one such document. FIG. 2 is a flow diagram showing a computer-implemented method 30 for dynamically generating documents based on user context, in accordance with one embodiment. Contextual data is collected (block 31) for a user. The contextual data can include location, time, vital statistics, acceleration and movement data, email, text messages, video, and voice recordings. Other types of contextual data are possible. The contextual data can be collected continuously, periodically, or randomly.

In one embodiment, at least a portion of the contextual data can be used to determine a context of the user. For instance, coordinates determined by GPS can be used to identify a contextual situation as one that is occurring at a location associated with the coordinates. In one example, a user's location identifies his presence at Northgate Mall in Seattle, Wash. In another example, time and date can be used to determine a contextual situation, such as by determining a time for a user experiencing a contextual situation. For instance, on a Monday night at 8 p.m., the user routinely attends Spanish class. Also, vital statistics and acceleration can be used to identify a contextual situation in which the user is running, which can be determined based on a level of acceleration and heart rate collected by a health tracker. Other contexts or contextual situations can be determined based on the same or different items of contextual data.

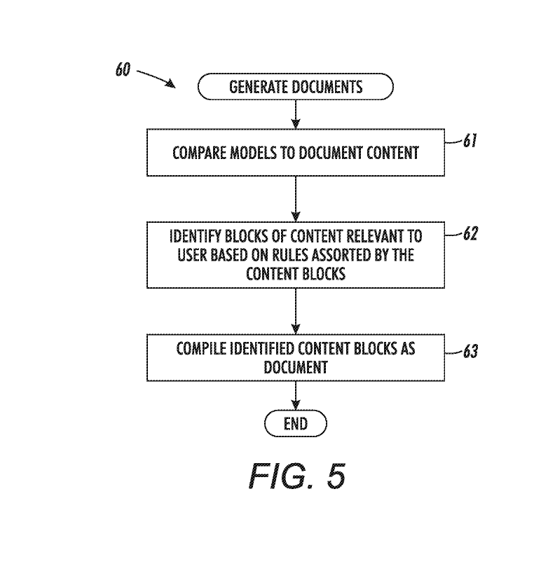

One or more user models can be selected (block 32) based on the context of the user. Further, a document or display on which the document is to be presented can also be identified (block 33) based on the user's context. The document or display can be identified based on a location of the user, a subject of focus of the user, or based on a user check-in to a particular location on a social networking site, as well as via other methods. For example, a user is wearing a head-mounted computing device and is determined to be standing in front of an interactive display at a grocery store based on a photograph captured by a camera on the head-mounted computing device. Identification of the display is then used to identify the documents to be presented on that display, which can subsequently be tailored to the user by generating (block 34) one or more documents for presentation to the user. Specifically, the document can be generated by selecting content related to the user for inclusion in the document, as further described below with reference to FIG. 5. Once generated, each document can be presented (block 35) to the user.

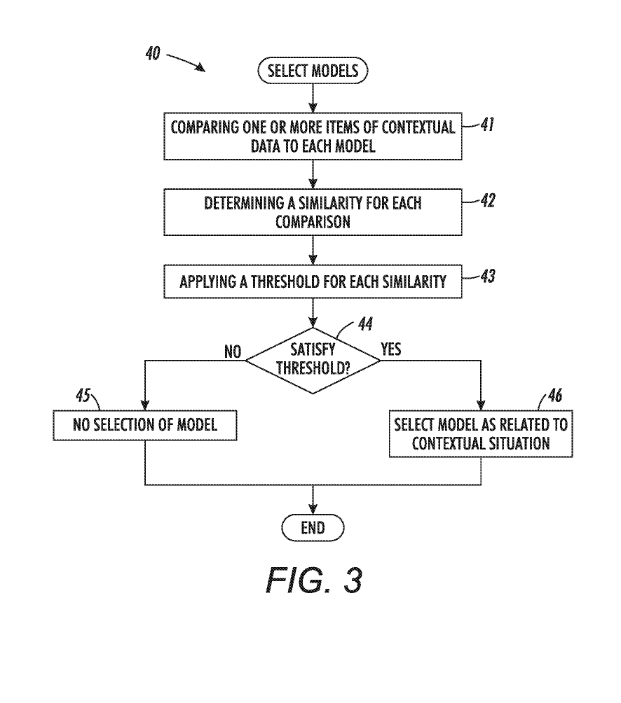

Identifying models relevant to a context of a user helps determine content to be included in one or more documents for presentation to the user during that context. FIG. 3 is a flow diagram showing, by way of example, a process 30 for selecting user models. One or more items of contextual data collected for a user are compared (block 41) to each existing context model for that user. A similarity value for each comparison is determined (block 42) and in one embodiment, a threshold is applied (block 43) to each similarity value. If a similarity value fails to satisfy (block 44) the threshold, the model associated with the similarity value is not selected (block 45) as related to the current context of the user. However, if the similarity value satisfies (block 44) the threshold, the model for the previous contextual situation is selected (block 46) as relevant to the user's current context.

In one example of dynamic document generation, a user is carrying his mobile phone and wearing a fitness tracker. The mobile phone collects GPS coordinates, which can be used to determine the user's location, while the fitness tracker collects acceleration data for the user. Based on the contextual data collected, the user is determined to be sitting at a table at Southern Kitchen restaurant. Upon determining the user's location, one or more models can be identified and selected as relevant to the user's current context. In this example, models related to restaurant outings are identified, including a model for a previous visit to Southern Kitchen. In a further embodiment, the models for the restaurant visits can be combined into a single model, which is then selected.

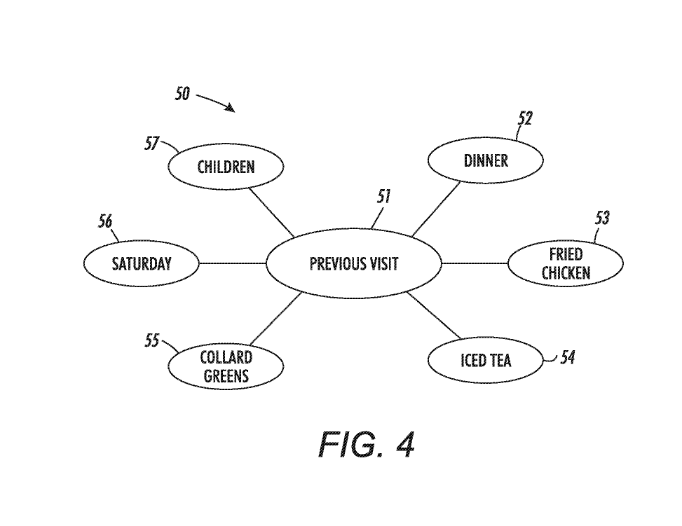

Each table at Southern Kitchen has a tablet on which menus and advertisement are displayed. Thus, the tablet is identified as a display for documents, such as the menu and advertisements, to be presented to the user. One or more of the documents to be displayed are generated by selecting the content of the document based on the selected models for the user. In this example, the selected models include other restaurant visits and a previous visit to Southern Kitchen. FIG. 4 is a block diagram showing, by way of example, a user model 50. The user model 50 represents a previous dining experience 51, such as the user's previous visit to Southern Kitchen. The model 50 includes a collection of nodes, each representing an action during the contextual situation for the previous visit, which are connected by edges. For this model, the nodes include having dinner 52, eating fried chicken 53, drinking iced tea 54, eating collard greens 55, visiting the restaurant on a Saturday 56, and bringing at least one child to the restaurant 57.

A menu is identified as the next document to be to be displayed since the user is sitting at the restaurant table and has not yet ordered. The menu document is generated by selecting content relevant to the user for compiling as the document. FIG. 5 is a flow diagram showing, by way of example, a process 60 for generating documents. The models selected for the user are compared (block 61) with blocks of content. Each content block can include a sentence, list item, paragraph, or other segment of data. Each content block is associated with one or more context rules that can be used to determine whether the associated content block should be presented in a document for the user. The rules can be generated by a creator of the content blocks or another individual, such as an administrator or manager.

Returning to the above restaurant example, the content blocks for a menu can include menu items with a description of that item and a price. Each rule can be attached to one or more content blocks and can include, for example, “select the content block when the user has previously ordered the menu item associated with that content block,” “present all pasta dishes when the user likes Italian food,” and “do not present seafood dishes when the user has a shellfish allergy.” Additionally, for a specific type of document, one or more content blocks may be included for every user to which the document is distributed, while the remaining content blocks are selected based on the user. For example, an advertisement for a popular nightclub may have a content block for drink prices that are included for every user. However, content blocks for particular theme nights at the nightclub are selected based on the user, such that those users that like hip hop music are provided with club information for Friday nights, while those users that like Latin music are provided with information for Wednesday nights.

During the comparison, the actions of the user models are used to determine whether one or more content blocks should be selected for inclusion in the document based on the rules. Specifically, if one or more actions or a pattern of the actions satisfies a rule, the content block associated with that rule is selected (block 62) for inclusion. However, if the rule for a content block is not satisfied by the selected models, the content block is not included in the document. Finally, all the content blocks selected for inclusion in the document are compiled (block 63) for presenting to the user.

Returning to the above restaurant example, the menu document is generated by selecting content for the document based on the user's actions recorded in the models for the previous restaurant visit and the other restaurant visits. During the user's previous visit, as determined by the model, the user ordered fried chicken, collard greens, and iced tea. Each of those menu items are associated with a rule that indicates that the menu item should be selected for inclusion when previously ordered by the user. Therefore, the menu items for fried chicken, collard greens, and iced tea are selected for inclusion in the menu document. A message or note can also be provided with those menu items informing the user that he ordered those items during his last visit. Also, since the user previously visited the restaurant with children, the children's menu can also be included in the document. Further, based on the user's visits to other restaurants, a determination is made that the user does not prefer seafood since the user has never ordered seafood and thus, the fried catfish menu item is not included in the menu document. Once content for the menu document has been selected and compiled, the menu is displayed to the user via the tablet on the table.

Although dynamic document generation has been described above with respect to a menu, other documents are possible. For example, an instruction document for installing software can be generated based on computer experience of the user, such that those users with less experience are provided with detailed instructions, while users with more experience are provided with less detailed instructions. Thus, some of the content blocks may be relevant to and provided to both users, while other content blocks are only relevant to either users with more or less experience. Additionally, at least a portion of one or more content blocks may be highlighted for the user based on a relevance of that information to the user.

While the invention has been particularly shown and described as referenced to the embodiments thereof, those skilled in the art will understand that the foregoing and other changes in form and detail may be made therein without departing from the spirit and scope of the invention.

What is claimed is:

1. A computer-implemented system for dynamically generating documents based on user context, comprising:
a database to maintain blocks of document content;
a collection module to collect contextual data of a user;
a comparison module to compare the contextual data to a set of stored models for the user;
an identification module to identify one or more models related to the user's context;
a selection module to select one or more content blocks based on the identified models; and
a generator to generate a document for the user by compiling the selected content blocks.

2. A system according to claim 1, further comprising:
a rule association module to associate one or more rules with each document content block.

3. A system according to claim 2, wherein each rule defines one or more contexts appropriate for the content associated with the document content blocks associated with that rule.

4. A system according to claim 2, wherein the document content blocks are selected by comparing the identified models with the rules associated with the document content blocks and selecting those document content blocks with rules satisfied by the identified models.

5. A system according to claim 1, further comprising:
a display to display the generated document.

6. A system according to claim 1, further comprising:
a modification module to modify the generated document for presentation to a different user.

7. A system according to claim 1, further comprising:
a determination module to determine an identity of the user and to obtain the models for the user based on the user identity.

8. A system according to claim 1, further comprising:
a determination module to determine the document for selection, comprising at least one of:
a location determination module to determine a location of the user and selecting a document at that location as the identified document; and
a focus determination module to determine a focus of the user and selecting a document that is the focus of the user as the identified document.

9. A system according to claim 1, further comprising:
a similarity determination module to determine a similarity between each model and the contextual data based on one or more of location, time, goal, action and recommendation.

10. A system according to claim 1, wherein the contextual data comprises one or more of time, location, date, day, temperature, vital sign, and acceleration.

11. A computer-implemented method for dynamically generating documents based on user context, comprising:
maintaining blocks of document content;
collecting contextual data of a user;
comparing the contextual data to a set of stored models for the user;
identifying one or more models related to the user's context;
selecting one or more content blocks based on the identified models; and
generating a document for the user by compiling the selected content blocks.

12. A method according to claim 11, further comprising:
associating one or more rules with each document content block.

13. A method according to claim 12, wherein each rule defines one or more contexts appropriate for the content associated with the document content blocks associated with that rule.

14. A method according to claim 12, wherein the document content blocks are selected, comprising:
comparing the identified models with the rules associated with the document content blocks; and
selecting those document content blocks with rules satisfied by the identified models.

15. A method according to claim 11, further comprising:
displaying the generated document.

16. A method according to claim 11, further comprising:
modifying the generated document for presentation to a different user.

17. A method according to claim 11, further comprising:
determining an identity of the user; and
obtaining the models for the user based on the user identity.

18. A method according to claim 11, further comprising:
determining the document for selection, comprising at least one of:
determining a location of the user and selecting a document at that location as the identified document; and
determining a focus of the user and selecting a document that is the focus of the user as the identified document.

19. A method according to claim 11, further comprising:
determining a similarity between each model and the contextual data based on one or more of location, time, goal, action, and recommendation.

20. A method according to claim 11, wherein the contextual data comprises one or more of time, location, date, day, temperature, vital sign, and acceleration.
